(19) United States
(12) Patent Application Publication
(10) Pub. No.: US 2012/0018961 A1
(43) Pub. Date: Jan. 26, 2012

(54) LUBRICATION OF A PIPE OR CABLE LEAD-THROUGH

(75) Inventors: Jens Andersson, Hasslo (SE); Mats Ericson, Asarum (SE); Jenny Filipsen, Karlskrona (SE); Ulf Hildingsson, Nattraby (SE); Christer Lundborg, Karlskrona (SE); Stefan Milton, Ramdala (SE); Ronnie Petterson, Jamjo (SE); Jörgen Åkesson, Lyckeby (SE)

(73) Assignee: Roxtec AB, Karlskrona (SE)

(21) Appl. No.: 13/138,151

(22) PCT Filed: Feb. 2, 2010
(86) PCT No.: PCT/EP2010/051236

§ 371 Date: Oct. 5, 2011

(30) Foreign Application Priority Data
Feb. 4, 2009 (SE) 0950041-4

(51) Int. Cl. H02G 3/22; F16L 5/02; F16J 15/02

(52) U.S. Cl. 277/627

(57) ABSTRACT

A seal, lead-through or transit for cables, wires or pipes comprises a base part having a groove for receiving the cable etc. and in which groove a number of peelable sheets is received. The seal etc. may be designed to automatically give low friction and enhanced sealing between a cable etc. and the sheets and between the base parts at installation.

### TECHNICAL FIELD

The present invention concerns a seal, lead-through or transit for cables, wires or pipes. The invention especially concerns parts of the seal or transition, having peelable sheets for adaptation to diameters of a cable or pipe to be received.

### PRIOR ART

In the prior art there are cable transitions or the like having a frame, inside which a number of modules to receive cables, wires or pipes are placed. The modules are made of an elastic material e.g. rubber or plastics and are thus compressible. Inside the frame normally a number of modules are received side by side in one or more rows together with some kind of compression unit. The compression unit is placed between the frame and the modules in such a way that when the compression unit is expanded the compressible modules will be compressed around the cables, wires or pipes. For ease of description the expression “cable” is mainly used in this description, but it should be construed broadly and a person skilled in the art realises that it normally also covers pipes or wires.

Another type of seal, cable transition, pipe penetration etc. has a general cylindrical form and is to be received in a sleeve in a wall or an opening in a wall. To function in the desired way the seal should fit snugly into the sleeve or the opening of the wall in which it is received and the seal should be adaptable to the actual mounting dimension. The mounting dimension is dictated by the inner diameter of the sleeve or the opening. The seal has a cylindrical compressible body, which is compressed axially between fittings at the opposite ends of the compressible body. By the axial compression the cylindrical body will expand radially both inwards and outwards. Furthermore, the pipes or cables received may have different outer diameters, and, thus, the module should be adaptable to cables or pipes having different outer diameters.

Seals or transitions of both the above kinds are used for sealing in many different environments, such as for cabinets, technical shelters, junction boxes and machines. They are used in different industrial environments, such as automotive, telecom, power generation and distribution, as well as marine and offshore. The seals or transitions may have to seal against fluid, gas, fire, rodents, termites, dust, moisture etc., and may receive cables or wires for electricity, communication, computers etc., pipes for different gases or liquids such as water, compressed air, hydraulic fluid and cooking gas or wires for load retention.

The parts receiving a single cable etc. of both the types discussed above often have a pack of peelable layers or sheets on the inside. The layers or sheets are peeled off one-by-one until the inner diameter of the part is adapted to the outer diameter of the cable received in said part. The sheets adhere strong enough to each other to stay together and at the same time loose enough to enable the sheets to be peeled off from the stack, either one-by-one or a number of sheets together. In some embodiments there are also peelable layers or sheets on the outside, making it possible to adapt the outer dimensions of for instance a circular seal to a specific opening or sleeve.

A person skilled in the art realises that the exact shape and form of the different parts, including the layers, may vary without departing from the gist of the present invention. For example the pack of layers may have another cross sectional form than circular.

In order to provide an even compression and a secure seal the layers are lubricated before the cable or pipe is received. The lubrication is normally performed manually, using some kind of container for the lubricant.

### SUMMARY

To give the desired even compression and a secure seal, the friction between the cable or pipe and the part receiving said cable or pipe should be low. The low friction may be given by adding a lubricant. The lubricant will also fill out possible voids between different parts. According to one aspect of the present invention the seal or transition comprises a sort of automatic lubrication system or self-lubricating system. Automatic lubrication systems save time at installation, obviating that one forgets to apply the lubricant. According to another aspect some parts are subjected to a surface treatment system before use. According to a further aspect the low friction is given to the different parts at manufacture. In one example the surfaces are furnished with whiskers. In another example openings are formed on the surfaces.

By having an automatic lubrication system installation is simplified. When lubricating by hand there is a risk that too little lubricant is added. If the amount of lubricant is too low there is a substantial risk that the sealing effect will be too low. As stated above the lubricant will fill out possible voids between a cable etc. and the sheets or between modules. By means of the present invention it is possible to control that the correct lubricant is used and that it is feed out at the correct amount.

The low friction given by the lubricant facilitates installation of the last modules, i.e. when a frame or the like is almost filled with modules.

Further objects and advantages of the present invention will be obvious to a person skilled in the art reading the detailed description below.

### BRIEF DESCRIPTION OF THE DRAWINGS

The invention will be described more closely below by way of example and with reference to the enclosed drawings. In the drawings:

FIG. 1 is a plan view of one example of a cable or pipe transition,

FIG. 2 is a perspective view of a module half that may be used in the transition of FIG. 1,

FIG. 3 is a perspective view of a part of an alternative seal or transition for a cable or pipe,

FIGS. 4 and 5 are sketches indicating examples of automatic lubrication systems,

FIG. 6 is a cross section sketch indicating a further example of an automatic lubrication system,

FIG. 7 is a sketch indicating a first example of a surface treatment system, and

FIG. 8 is a sketch indicating a second example of a surface treatment system.

### DETAILED DESCRIPTION OF DIFFERENT EMBODIMENTS

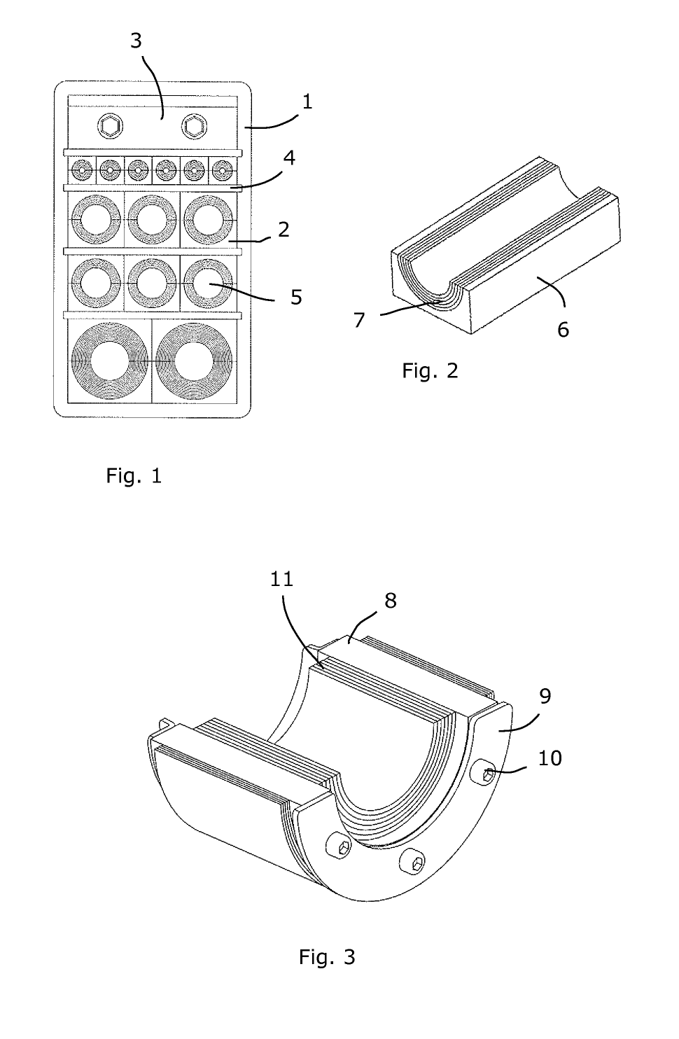

A common type of seals or transitions for cables and/or pipes is indicated in FIG. 1. It has an outer frame 1 received in a wall or any other type of partition. Inside the frame 1 a number of modules 2 are arranged to receive a single cable or pipe each. Furthermore, a compression unit 3 is received inside the frame 1. The modules 2 are separated by stay plates 4, which stay plates 4 are arranged to position the modules 2 safely inside the frame 1. The modules 2 are compressible parts of the seal or transition. Each module 2 has a central blind 5, which is removed when the cable or pipe is received.

An alternative system including a frame is described in the simultaneously filed application entitled “Sealing System”, filed by the applicant of the present application. This application is hereby incorporated by reference.

In FIG. 2 a module half is shown, which corresponds with the modules 2 of FIG. 1. The module half has a base part 6 with a generally rectangular appearance, having a semi cylindrical groove at one side. Inside the semi cylindrical groove of the base part 6 a number of peelable sheets 7 are received. In use two module halves are put together with the grooves facing each other. The module thus formed will have a central cylindrical opening, in which a cable or pipe is to be received. When a cable or pipe is to be received an appropriate number of sheets 7 are peeled off from each base part 6 in order to adapt the inner diameter of the cylindrical opening of the module to the outer diameter of the cable or pipe to be received. Thus, when a module 2 is to receive a cable or a pipe the blind 5 is first removed and then a number of sheets 7 are peeled off. When all pipes and/or cables have been placed in a module 2 each, the compression unit 3 is activated. The function of the compression unit 3 is to expand inside the frame 1. As the compression unit expands it will compress the modules 2, which are made of a compressible material such as rubber. The modules 2 will be compressed in one direction and expand in other directions, pressing the modules 2 against the frame 1.

Alternative embodiments of the modules are given in the simultaneously filed applications entitled “A Module of a Pipe or Cable Lead-Through having Grooves on Opposite Sides”, “Pipe or Cable Lead-Through Blocks”, “A Pipe or Cable Lead-Through having Modularized Modules” and “Modules of a Pipe or Cable Lead-Through having Alternating Geometry” filed by the applicant of the present application. In one embodiment the modules are separated from a stack of module halves sticking together, as described in the simultaneously filed application named “Modules of Pipe or Cable Lead-Through Sticking Together”, filed by the applicant of the present application. These applications are hereby incorporated by reference.

FIG. 3 shows a lower half of one example of a cylindrical seal or transition. It has a base part 8 and fittings at both ends. A forward fitting 9 is clearly visible in FIG. 3. The base part 8 is made of an elastic material and, thus, is a compressible part of the seal or transition. A number of screws 10 go between the fittings and through the base part 8. By means of the screws 10 the fittings may be moved toward each other, compressing the base part 8 in axial direction, whereby the base part 8 will expand in radial direction, both inwards and outwards. The radial expansion of the base part 8 will press inwardly against a cable or pipe and outwardly against an opening or a sleeve receiving the cylindrical seal or transition. In the seal of FIG. 3 a number of peelable sheets 11 are placed on an inner diameter of the seal. A suitable number of sheets 11 are peeled off to adapt the seal or transition to a cable or pipe to be received. In the shown embodiment there are also a number of peelable sheets on the outside of the base part 8. Making it possible to amend the outer diameter of the seal.

The sheets may be arranged in many different ways and with different features as reflected in the simultaneously filed applications entitled “A Pipe or Cable Lead-Through having Interconnected Layers”, “A Pipe or Cable Lead-Through having Layers of Different Thickness”, “A Pipe or Cable Lead-Through having a Part Indicating Compression”, “Cohering Between Layers of a Pipe or Cable Lead-Through”, “Identification of Layers of a Pipe or Cable Lead-Through”, “A Pipe or Cable Lead-Through having Penetrateable Modules”, “A Pipe or Cable Lead-Through having Modules with a Dimensioning Function” and “A Pipe or Cable Lead-Through having Layers of Alternating Geometry”, filed by the applicant of the present application. These applications are hereby incorporated by reference.

Previously the base part 6, 8 and the peelable sheets 7, 11 were lubricated by hand before installation. The lubricant was normally applied after that the appropriate amount of sheets 7, 11 had been peeled off. As indicated above one function of the lubricant is to provide an even compression and a secure seal.

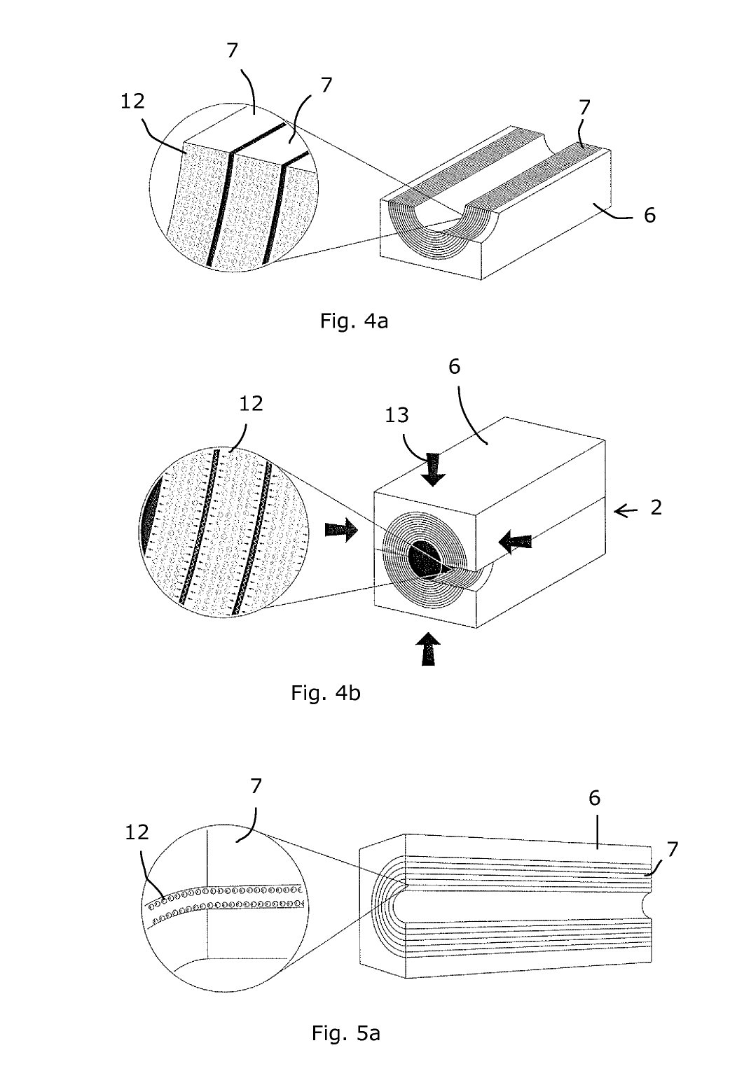

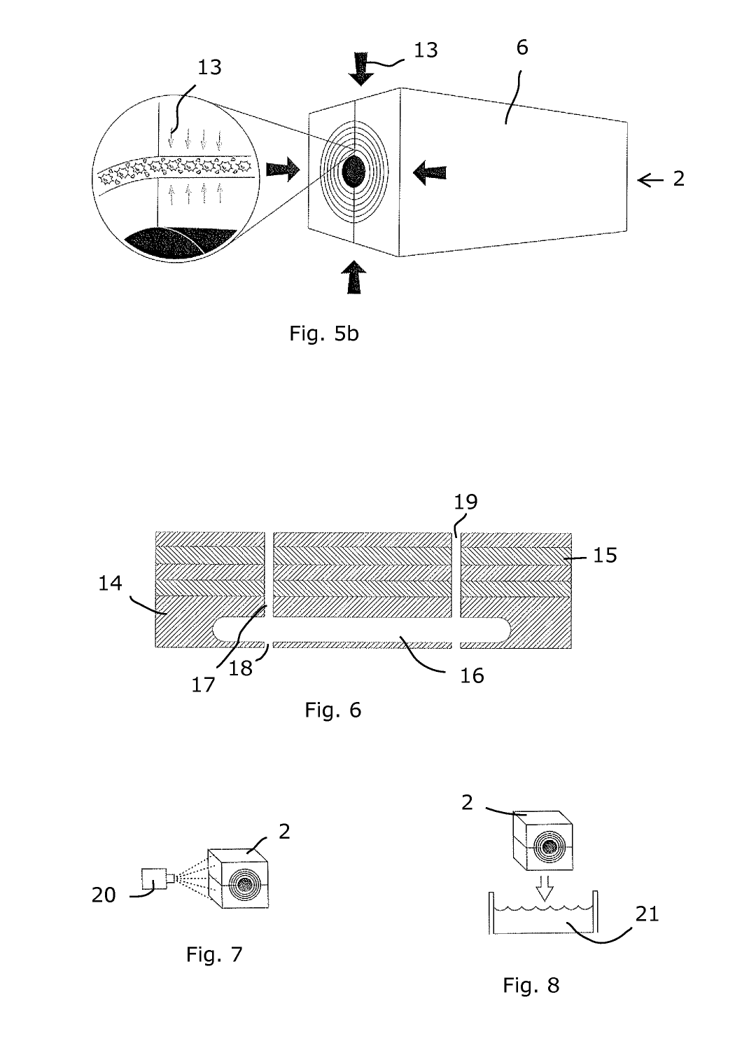

In the examples of FIGS. 4 and 5 the same reference signs are used for the different parts as in the previous Figs. In FIG. 4a a module half 6 is shown having peelable sheets 7. In the encircled enlargement to the left the sheets 7 are shown at a distance in illustrative purpose. In practice the sheets 7 adhere to each other. A lubricant is received in the form of bubbles 12 inside the sheets 7. The lubricant in form of bubbles is normally also received inside the module halves 6, even though not shown here. FIG. 4b illustrates the situation when a compression force 13 is applied to the module 2. By the compression force 13, the bubbles 12 will burst releasing the lubricant, which will wander toward the surface of respective sheet 7 and the surface of the modules halves 6. According to one theory the bubbles 12 closest to the surface will burst first. In the example of FIG. 5 a lubricant is encapsulated in bubbles 12 at the surface of respective peelable sheet 7 and modules base part. Also in FIG. 5 the sheets 7 are shown at a distance in the enlargement for illustrative purposes. The bubbles 12 are placed on the surface either as isolated bubbles 12 or as bubbles 12 sticking together. When a compression force 13 is applied the bubbles 12 will burst releasing the lubricant inside each bubble 12. This is indicated in FIG. 5b. The bubbles may be formed of a lubricant or an adhesive having a plastic shell. When the bubbles comprises an adhesive, the adhesive normally first acts as a lubricant and will only solidify after been exposed to the air for a period of time. Thereby, an improved sealing is achieved. In another embodiment the lubricant or adhesive has the form of small balls that will melt from the heat of friction at compression. A person skilled in the art realises that the cylindrical seal of FIG. 3 may have corresponding automatic lubrication as described above for the rectangular modules.

In all of the above embodiments the lubricant is originally placed separated from the material of each base part 6, 8 as such. Thus, the lubricant is not fully mixed into the material of the base parts 6, 8.

In FIG. 6 a base part 14 is shown, receiving a number of peelable sheets 15, in the same way as described above. The base part 14 has one or more reservoirs 16 for a lubricant. One or more channels 17 goes from each reservoir 16 and opens on the bottom of the groove receiving the peelable sheets 15. The peelable sheets 15 have openings 19 placed in line with each channel 17 of the base part 14. The reservoir 16 also has one or more channels 18 opening on a bottom surface of the base part 14. The bottom surface is placed on the opposite side of the base part 14 compared to the peelable sheets 15. Under compression the lubricant will go from the one or more reservoirs 16, through the channels 17, 18 of the base part 14, through the openings 19 of the peelable sheets 15, onto the surface of the sheet placed against a cable or pipe received in the module and onto the bottom surface of the base part 14. The lubricant used in this example should have a relatively low viscosity.

In an alternative embodiment a low friction material is applied to the modules 2 after extrusion and vulcanization. The low friction material may be applied by spraying, as indicated in FIG. 7 by means of a nozzle 20. Another way of applying the low friction material is to dip the module 2 into a liquid bath 21, as indicated in FIG. 8. Furthermore, the low friction and enhanced sealing may be given by applying a lubricating and sealing component on the different surfaces at manufacture. In a further embodiment a stripe of lubricant protected by a removable foil is placed on the module. Before mounting, the foil is removed.

A person skilled in the art realises that lubricants having different viscosity may be used in the different embodiments. For instance the lubricant may have the form of a gel.

In another embodiment the low friction is given in that the different surfaces are modified in some way. The modification may be that the surfaces have small whiskers or that the surfaces have a number of small openings.

The different examples of embodiments shown in FIGS. 4-8 may be utilized independently of which types of base parts 6, 14 that are used.

In a further embodiment a lubricant is enclosed in the blind 5. In use the lubricant of the blind 5 is applied manually. In that the blind 5 is always removed before a cable or pipe is received, the lubricant will be ready to hand.

The seal, lead-through or transit of the present invention may also have openings, the direction of which may be altered in order to receive cables, pipes or wires that are inclined in relation to the seal, lead-through or transit. The flexibility regarding inclined cables, pipes or wires may be accomplished in that an inner part receiving the cable etc. is received turnable inside an outer fixed part. Such an arrangement is described in the applicant's international patent application PCT/SE2008/050940.

In alternative embodiments the seal, lead-through or transit of the present invention is furnished with eccentrically placed openings for a cable, pipe or wire as shown in the simultaneously filed application entitled “Eccentric Part of a Pipe or Cable Lead-Through”, filed by the applicant of the present application. This application is hereby incorporated by reference.

1. A seal/transition, comprising:
base parts having a groove to receive at least one of a cable and a pipe, and in which groove a number of peelable sheets is received, wherein the seal/transition has an automatic lubrication system to give a low friction and enhanced sealing between the cable or pipe received and the sheet abutting said at least one cable and pipe after installation and to give low friction and enhanced sealing between the base parts.

2. The seal/transition of claim 1, wherein the automatic lubrication system is given by a lubricant encapsulated in bubbles placed at a surface of each peelable sheet and/or each base part.

3. The seal/transition of claim 2, wherein the bubbles are made to burst and release the lubricant if a compression force is applied on the base part.

4. The seal/transition of claim 2, wherein the bubbles are made to burst by friction.

5. The seal/transition of claim 3, wherein the bubbles are isolated from each other.

6. The seal/transition of claim 3, wherein the bubbles stick together.

7. The seal/transition of claim 2, wherein the bubbles comprise an adhesive, initially acting as a lubricant and which adhesive is solidified after exposure to air for a period of time, whereby the sealing is enhanced after the lubricant solidifies.

8. The seal/transition of claim 1, wherein the automatic lubrication system is given in that the base part encloses at least one reservoir receiving a lubricant and at least one channel going from the at least one reservoir to at least one surface of the base part.

9. The seal/transition of claim 8, wherein the peelable sheets have openings placed in line with the at least one channel.

10. The seal/transition of claim 1, wherein the peelable sheets have whiskers projecting from a surface.

11. The seal/transition of claim 1, wherein a low friction material is applied to the base parts and the peelable sheets after extrusion and/or vulcanization of the base parts and the peelable sheets.

12. The seal/transition of claim 11, wherein the low friction material is applied by spraying of a nozzle.

13. The seal/transition of claim 11, wherein the low friction material is applied in that the base parts and the peelable sheets are immersed in a liquid bath.

14. The seal/transition of claim 1, wherein the low friction and the enhanced sealing is given by a component applied on the surface at manufacture, which component is covered by a removable foil.

15. The seal/transition of claim 3, wherein the bubbles comprise an adhesive, initially acting as a lubricant and which adhesive is solidified after exposure to air for a period of time, whereby the sealing is enhanced after the lubricant solidifies.

16. The seal/transition of claim 4, wherein the bubbles comprise an adhesive, initially acting as a lubricant and which adhesive is solidified after exposure to air for a period of time, whereby the sealing is enhanced after the lubricant solidifies.

17. The seal/transition of claim 5, wherein the bubbles comprise an adhesive, initially acting as a lubricant and which adhesive is solidified after exposure to air for a period of time, whereby the sealing is enhanced after the lubricant solidifies.

18. The seal/transition of claim 6, wherein the bubbles comprise an adhesive, initially acting as a lubricant and which adhesive is solidified after exposure to air for a period of time, whereby the sealing is enhanced after the lubricant solidifies.
